(19) United States
(12) Patent Application Publication
(10) Pub. No.: US 2002/0041804 A1
(43) Pub. Date: Apr. 11, 2002

(54) Apparatus for conveying printed products to a hopper

(76) Inventor: Gary D. Cooper, Metairie, LA (US)

Correspondence Address: KRAMER LEVIN NAFTALIS & FRANKEL LLP, 919 THIRD AVENUE, NEW YORK, NY, 10022, US

(21) Appl. No.: 09/963,357

(22) Filed: Sep. 26, 2001

Related U.S. Application Data
(60) Provisional application No. 60/235,845, filed on Sep. 27, 2000.

(51) Int. Cl. B65G 59/06

(52) U.S. Cl. 414/795.7; 414/797.2; 414/900; 271/165

(57) ABSTRACT

A newspaper product conveyance device is provided for feeding a newspaper inserter including a chassis having a transfer belt extending at an incline between a first end of the chassis and a discharge area located adjacent a second end of the chassis. The conveyance device further comprises a roller assembly including a plurality of rollers, the roller assembly extends at an angle from the chassis adjacent the first end and defines with the first end of the chassis a newspaper product feed area for holding a stack of newspaper products. A motor is provided for advancing the transfer belt to move the newspaper products from the product feed area to the discharge area, whereby the roller assembly and transfer belt cooperate to cause a uniform stream of newspaper product to be transported to the discharge area for discharge to the inserter.

### RELATED APPLICATION DATA

This Application claims priority from previously filed U.S. Provisional Patent Application No. 60/235,845 filed on Sep. 27, 2000, the disclosure of which is incorporated by reference in its entirety.

### BACKGROUND OF THE INVENTION

The present invention relates generally to a paper conveying apparatus or device and more specifically to an apparatus or device that transports or conveys printed newspaper products from a supply such as a pallet to a newspaper inserter machine for newspaper assembly.

In the newspaper industry, assorted machines and apparatuses are employed to automate a variety of newspaper operations and processes. For example, in the packaging or mail center of a newspaper facility, the process of assembling the various newspaper sections, inserts and fliers into a complete newspaper (i.e., the newspaper assembly process) is typically machine assisted or automated. In particular, an inserting machine such as the type manufactured by Heidelberg, Harris Inc. or Sheridan Systems is used to automate practically the entire newspaper assembly process.

As is well known in the art, an inserter includes a plurality of stations for mechanically feeding the various printed products that comprise a complete newspaper. At each feeding station, a hopper is provided for receiving a stack of a particular type of newspaper section or insert. The newspaper sections may include comics, news or business sections. The inserts may include circulars, advertisements, advertising coupons and television guides that range in shape, dimension and texture.

The hopper may be loaded with printed products either manually or mechanically for feeding to the inserter. For manual loading of the hopper, one or more people physically move a stack of inserts or newspaper sections from a pallet or other supply directly into a receiving area formed within the hopper. Typically, prior to placing the stack into the hopper, the stack is manually jogged to separate and introduce air between the individual inserts or newspaper sections that comprise the stack. In addition, the hopper area may include a mechanical jogger for jogging the stack just prior to feeding the inserter. Jogging the stack prevents jamming of the inserter as individual newspaper sections or inserts are fed from the hopper into pockets in the inserter for newspaper assembly.

Alternatively, hoppers are loaded using a mechanical hopper loader. Known hopper loaders include the NP225 Hopper loader by Sheridan Systems. Conventional hopper loaders such as the NP225 comprise at least two independent conveyor assemblies for moving a stack of product from a supply (e.g., pallet) to a hopper. The first conveyor assembly is oriented in a horizontal plane and receives a manually pre-jogged stack of printed products. The stack of printed products is spread out or “shingled” manually to form a product stream that is fed from the first conveyor assembly to an incline conveyor assembly that feeds the inserts or newspaper sections to the hopper. At the top of the conventional hopper, a jogging assembly comprising a pair of jogging paddles is used to square or align the printed product stream just prior to reaching the hopper.

A control panel mounted to the hopper loader is also provided to set the speeds of the first and incline conveyor assemblies. The conveyor assemblies are typically controlled by a demand photo sensor that is synchronized with the rate at which inserts or newspaper products are fed from the hopper to the remainder of the inserter. That is, as the supply of newspaper sections or inserts go below a predefined height within the hopper, the demand photo sensor detects the reduced stack height and energizes the conveyor assemblies to transport additional printed products to the hopper until a suitable stack height is achieved.

These conventional or prior art hopper loaders are generally effective in feeding printed product to a hopper. However, the prior art design does suffer from a number of shortcomings or inefficiencies. For example, having to manually jog the stack before placing it on the first conveyor assembly delays the speed or frequency in which the hopper loader may be fed with additional product. As a result, the conveyor assemblies must be set at a speed that keeps pace with the loader who must manually jog and shingle the stack along the conveyor belt. This delay may result in a reduction of newspaper production.

Additionally, an uneven or inconsistent product stream may result since the shingling step must be performed manually. An uneven product stream may result in inconsistent feeding of product to the hopper. This may cause jamming of the inserter. In addition, an inconsistent product feed may result in an insert not being fed into a pocket (miss) or more than one insert being fed into a pocket (double).

It has also been found that conventional hopper loaders do not convey or transport inserts of varying dimension and texture with the same level of efficiency and consistency. That is, some small inserts or high-gloss inserts may not reach the hopper in a uniform product stream. This lack of uniformity in the product stream requires the operator to manually adjust the product stream at many different points along the conveyor assemblies. As a result, the operator spends too much time tending to the product stream to avoid jams, misses or doubles rather than feeding additional product onto the hopper loader for delivery to the hopper.

Finally, because conventional hopper loaders require two conveyor assemblies to move product from a supply to a hopper, the overall dimension or footprint of the conventional hopper loader is quite large. In the packaging center, space around the inserter is typically at a premium. As a result, the extra size of the conventional hopper loader may make it difficult to accommodate other equipment or machinery or additional personnel to manually load the hopper.

Accordingly, a need exists for a conveying device to deliver printed products to a hopper that delivers a uniform product stream while minimizing the need to manually jog and shingle printed product. A further need exists for a such a conveying device that may be adjusted to transport printed products of varying dimension and texture. A still further need exists for such a conveying device that utilizes a single conveying assembly to transport printed product to a hopper while reducing movement and ergonomically improving the conveying device for easier and more efficient manual loading of the conveying device.

### SUMMARY OF THE INVENTION

In view of the foregoing, it is an object of the present invention to provide an improved conveying device or apparatus for delivering printed products from a supply to a hopper.

It is still a further object of the present invention to provide such a device that delivers a uniform shingled product stream while requiring little or no manual pre-jogging or shingling.

It is still a further object of the present invention to provide such a device that may be easily adjusted to accommodate printed products of varying size and dimension without affecting the ability to deliver the printed product with a smooth and uniform shingled pattern.

It is yet a further object of the present invention to provide such a device or apparatus that may be easily modified to move the device from work station to work station.

In the present invention, the above objects are achieved by providing a conveying device for loading a hopper including (1) a tail roller conveyor assembly, (2) an incline conveyor assembly that utilizes a single variable speed transport/conveyor belt extending from a location adjacent the tail roller conveyor assembly to a nose portion of the conveying device, and (3) a linear jogging assembly mounted along the nose portion of the conveying device. The conveying device is controlled through a control panel that is preferably mounted to the device.

More particularly, a printed product conveyance device is provided including a chassis having a transport medium (e.g., transfer belt) that extends at an incline between a first end of the chassis and a second end thereof. The device further includes a support assembly that extends at an angle from the chassis adjacent the first end thereof and defines therewith a printed product feed area adapted to receive a stack of printed product. A means (e.g., motor) is provided for causing the transport medium to transfer printed product from the printed product feed area to a discharge area located adjacent the second end of the chassis, whereby the printed product is moved uniformly from the printed product feed area toward the discharge area under the action of the transport medium.

In another aspect of the present invention, the rear support assembly of the conveyance device is comprised of a plurality of rollers for assisting in the feeding of the printed product from the feed area to the discharge area, whereby the action of the plurality of rollers acts to separate the printed product as it moves along the transport medium to the discharge area.

In other aspects of the present invention, the conveyance device includes an alignment gate for maintaining the alignment of the product stream as it is transferred from the feed area to the discharge area. Further, a linear jogging assembly is used adjacent the discharge area to ensure that the printed product is evenly fed to the inserter.

As will be detailed herein, the conveying device for delivering printed product to a hopper according to the present invention provides a means of mechanically keeping the inserting machine hopper filled with newspaper sections and inserts to meet the high speed requirements of a newspaper packaging center. The preset pile or stack height in the inserter hopper is automatically maintained. The conveying device of the present invention is capable of feeding most products, preprints, pre-stuff packages and inserts.

Other objects and advantages of the invention will in part be obvious and will in part be apparent from the specification.

The present invention accordingly comprises the various features of construction, combination of elements, and arrangement of parts which will be exemplified in the constructions hereinafter set forth, and the scope of the invention will be indicated in the claims.

### BRIEF DESCRIPTION OF THE DRAWINGS

For a fuller understanding of the invention, reference is made to the following description, taken in connection with the accompanying drawings, in which:

FIG. 1 is a side perspective view of the conveying device according to an exemplary embodiment of the present invention;

FIG. 2 is a side perspective view of the opposite side of the conveying device according to an exemplary embodiment of the present invention;

FIG. 3 is an enlarged cross-sectional view taken along the line 3-3 in FIG. 1;

FIG. 4 is an enlarged sectional view taken along the line 4-4 in FIG. 2;

FIG. 5 is a detailed view of the adjustable fence taken along the line 5-5 in FIG. 2;

FIG. 6 is an enlarged sectional view taken along the line 6-6 in FIG. 2;

FIG. 7 is a detailed view of the reciprocating mechanism of the jogging assembly according to an exemplary embodiment of the present invention;

FIG. 8 is a detailed elevational view of the mounting assembly for securing the conveying device to an inserter according to an exemplary embodiment of the present invention;

FIG. 9 is a detailed sectional view of the mounting assembly taken along line 9-9 in FIG. 8; and

FIG. 10 is a detailed elevational view of the height adjustment assembly according to an exemplary embodiment of the present invention.

### DETAILED DESCRIPTION OF THE PREFERRED EMBODIMENTS

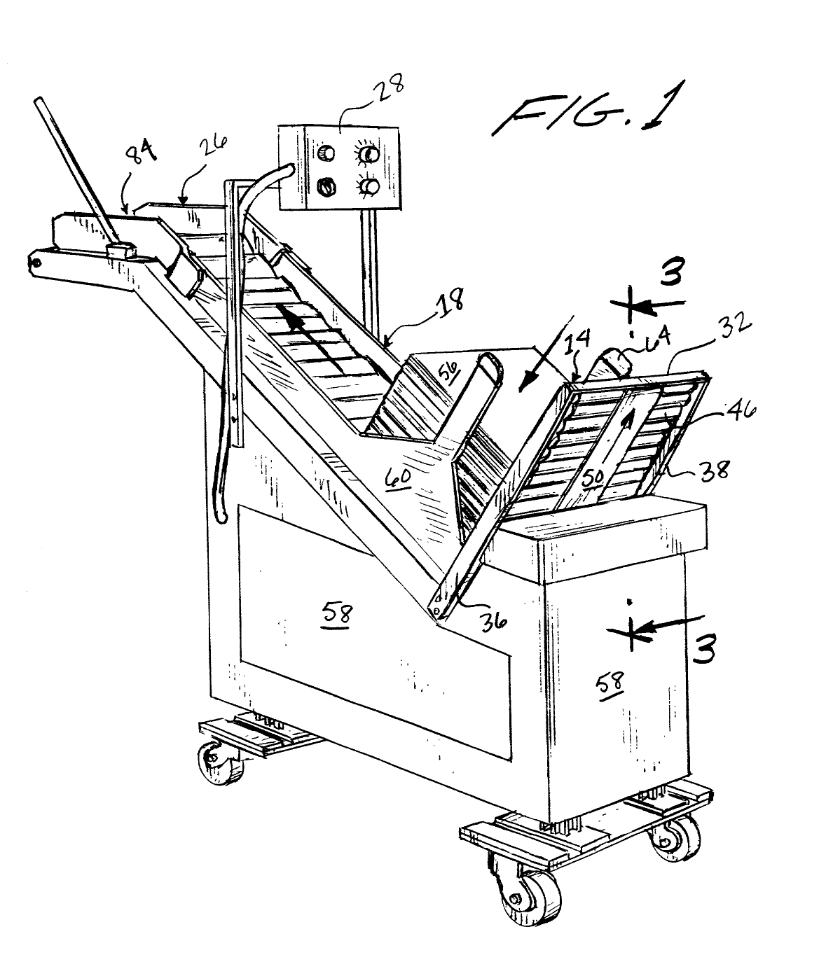

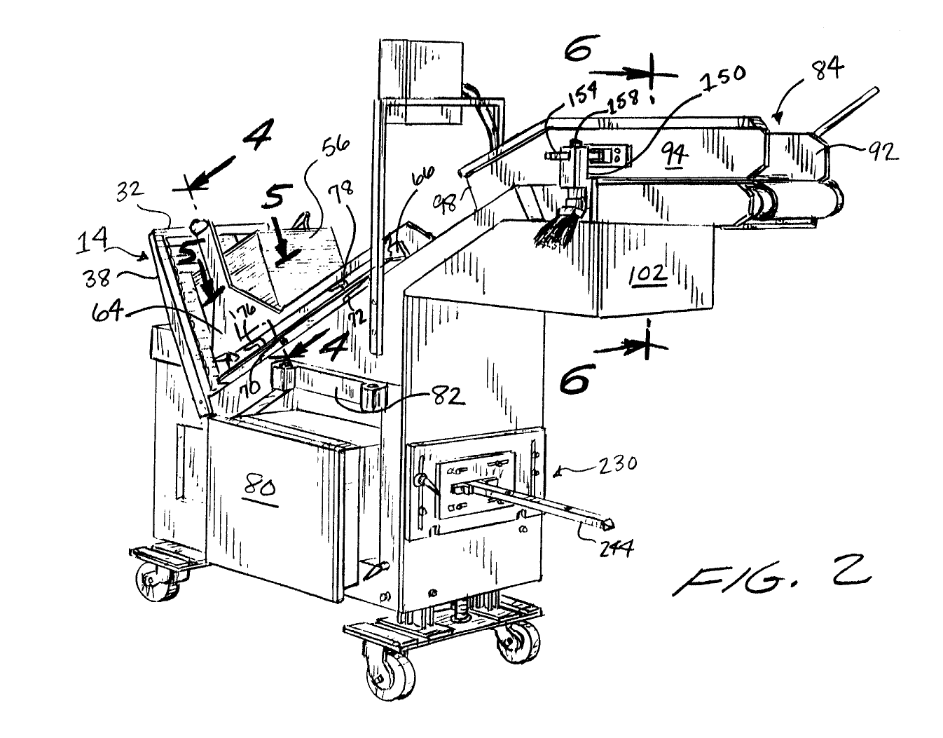

Reference is made to FIGS. 1 and 2 showing the general arrangement of a conveying device 10 for transporting printed products to a hopper according to an exemplary embodiment of the present invention. The conveying device 10 is shown as generally including a tail roller conveyor assembly 14, an incline conveyor assembly 18 utilizing a single variable speed transfer belt 22 and a linear jogging assembly 26.

The various components and moving assemblies of the conveying device 10 are controlled through a control panel 28 mounted to the chassis or frame of the conveying device 10. The control panel 28 and its operation are well known in the art. Additionally, as is also well known in the art, a demand photo sensor (not shown) is used to automatically control the flow of printed products from the conveying device 10 to the hopper.

An exemplary or preferred embodiment of the conveying device 10 and its operation will now be discussed in greater detail with reference to the accompanying drawings. In particular, referring now to FIGS. 1 through 3, the tail roller conveyor assembly 14 is shown as including a generally rectangular chassis or frame 32 (preferably steel). The frame 32 includes a pair of laterally spaced members 36, 38, each member 36, 38 including a plurality of spaced holes or bores. Each one of the bores or holes on lateral member 36 corresponds to a matching bore or hole located on opposite lateral member 38 such that between lateral members 36, 38 a succession of bore pairs are defined along the length of frame 32 to rotatably support a plurality of rollers 46.

Each roller 46 includes a pair of stub shafts at the ends thereof, at least one stub shaft being depressible (such as by spring loaded mounting of the stub shaft) to secure the roller within a bore pair between the first and second lateral members 36, 38. A belt 50, such as a heat-welded stretchy belt, may be mounted around the plurality of rollers 46 to prevent printed products from slipping between adjacent rollers 46.

The tail roller assembly 14 is joined to a first end of the incline conveyor assembly 18. The tail roller assembly 14 and incline conveyor assembly 18 may be manufactured as separate assemblies and joined such as by welding or bolting. Alternatively, the tail roller and incline conveyor assemblies 14, 18 may be manufactured as a single unitary chassis or frame.

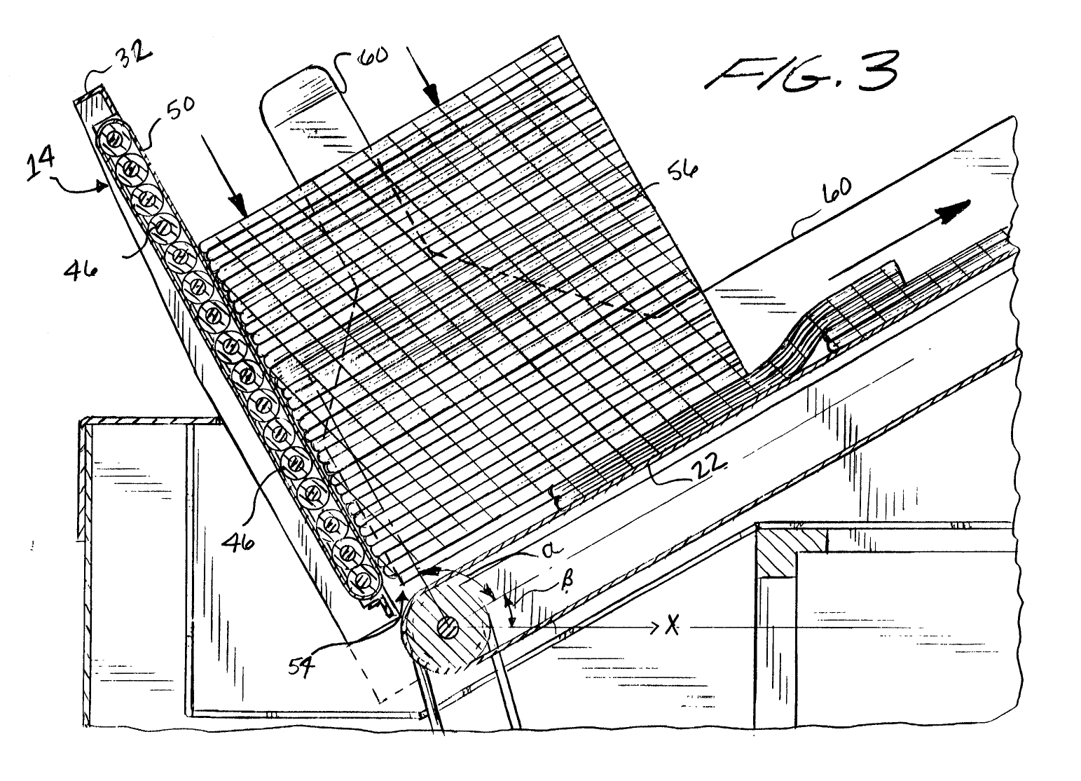

Referring now to FIG. 3, the printed product feed area 54 of conveying device 10 including a stack of printed products 56 to be fed to a hopper (not shown) of a conventional newspaper inserter is shown in detail. The printed product feed area 54 is formed at the junction of the tail roller assembly 14 and incline conveyor assembly 18 that is easily accessible by a person loading printed products to be moved up the incline conveyor assembly 18 to the hopper. The stack of printed products 56 is deposited in the product feed area 54 and transported on transfer belt 22 up the incline conveyor assembly 18 under the action of a drive assembly comprised of a roller chain, gearbox and DC drive motor located within housing 58 of conveying device 10. Drive assemblies of the type used to drive transfer belt 22 are well known in the art.

In an exemplary embodiment, the angle formed between the tail roller assembly 14 and incline conveyor assembly 18 is preferably approximately 90 degrees. That is, as shown in FIG. 3, the angle α formed between the plane defined by the tail roller assembly 14 and the plane defined by the incline conveyor assembly 18 is approximately 90 degrees. By setting this angle at approximately 90 degrees, the printed products sit squarely within the product feed area.

Additionally, to ensure a uniform shingled product stream, the incline conveyor assembly 18 is preferably pitched at an angle β ranging between approximately 20 degrees and 45 degrees as measured with respect to an X-axis, as shown in FIG. 3. Within this range of angles, the overall length of the conveying device 10 is minimized while maintaining a product feed area that sits at a height that is ergonomically suited to persons of average height. It should also be noted that pitching the angle beyond 45 degrees may cause uneven shingling of the product stream due to the increased action of gravity on the printed products as they move up the incline conveyor assembly 18.

Referring now to FIGS. 2 through 5, the printed product stream moves rectilinearly up the incline conveyor assembly 18 between a fixed paper guide 60 and an adjustable paper guide 64 The adjustable paper guide 64 may be moved inwardly toward the fixed guide 60 to accommodate printed products of different widths. As shown generally, in FIG. 2, the adjustable guide 64 is mounted to bracket or brace 66 which is secured to the incline conveyor assembly 18 at opposite ends thereof by pivot arms 70, 72 and Kipp handles 76, 78.

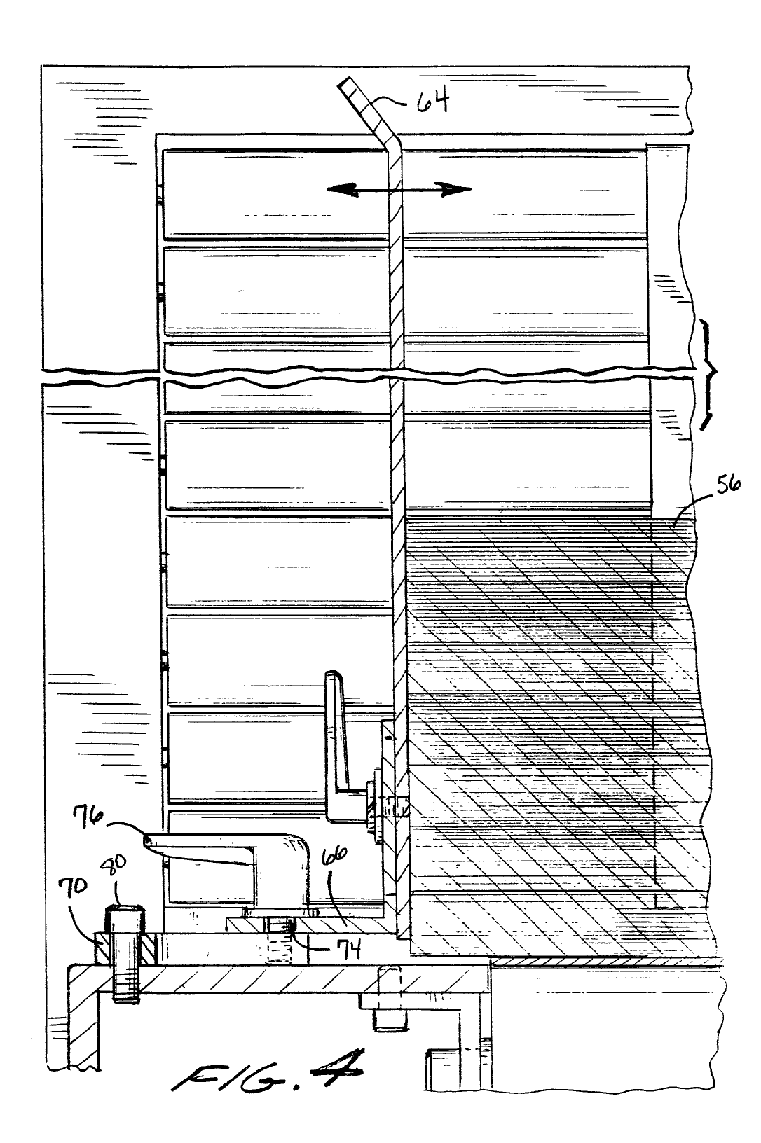

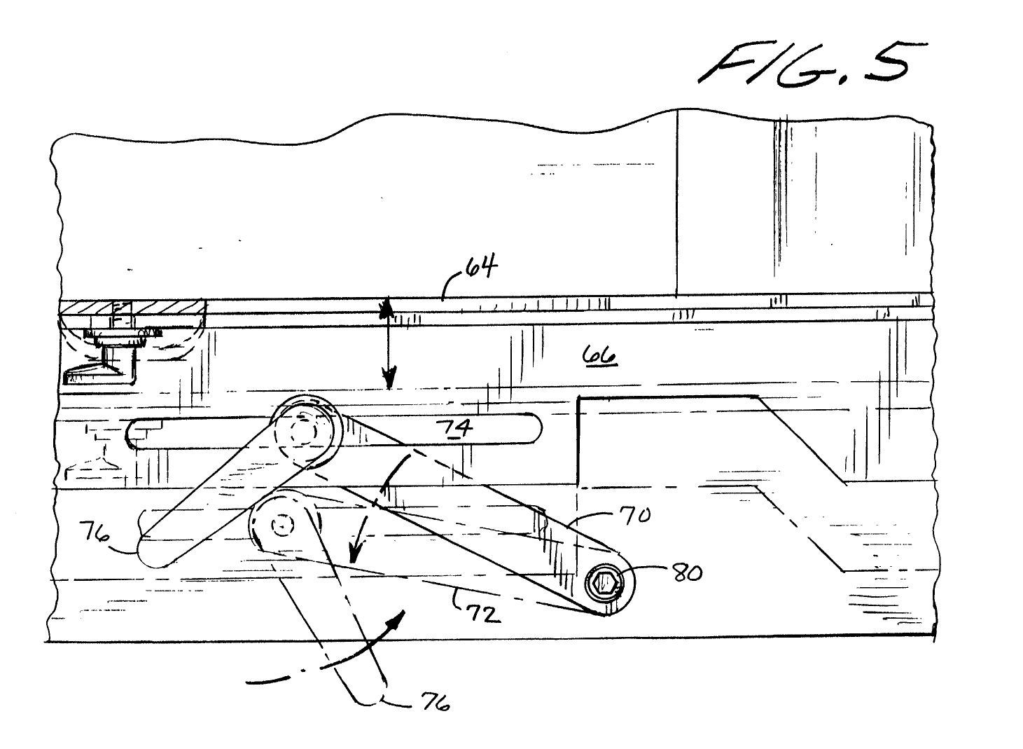

As shown in more detail in FIGS. 4 and 5, in order that paper guide 64 may be moved toward and away from fixed guide 60, arms 70, 72 are each pivotally mounted at a first end to incline conveyor assembly 18 by means of bolts 80. At the opposite ends of pivot arms 70, 72, each arm is slidably connected to brace 66. As shown in FIG. 5, brace 66 includes slots 74, 74 that receive Kipp handles 76, 78 to slidably connect pivot arms 70, 72 to brace 66. The Kipp handles 76, 78 may be manually loosened to free pivot arms 70, 72 to slide within slots 74, 74 as brace 66 is moved to vary the width of the product stream path, as shown in FIG. 5. After a desired width is obtained, Kipp handles 76, 78 may be manually tightened to lock the paper guide 64 in a fixed position.

Thus, as detailed above, an ergonomic conveying device 10 is achieved by mating the roller assembly 14 directly to the incline conveyor assembly 18. In such an embodiment, the plurality of rollers 46 form a low friction bearing surface that assists a person in loading a stack of printed products from a supply (e.g., pallet) onto the conveying device 10 as shown in FIG. 3. At the same time, the rollers 46 help to jog the stack as the printed products move up the incline conveyor assembly 18. The result is a uniformly shingled product stream automatically created under the influence of the transfer belt 22 as the product moves up the incline conveyor assembly 18 between the fixed paper guide 60 and adjustable paper guide 64 to a substantially horizontal nose section or discharge area 84.

In the event a type of printed product requires manual jogging, the conveying device 10 is equipped with a jogging table 80 that can be mounted in any one of a plurality of receivers 82 disposed around the periphery of the conveying device 10. The jogging table 80 which may be set up in any of the receivers 82, as shown in FIG. 2, may be used to manually jog the product before loading the printed product into the product feed area of the conveying device 10.

In a preferred embodiment, the nose portion 84 extends at least partly over the inserter in the vicinity of the hopper. Since inserters and their hoppers may have varying dimensions, the nose portion 84 may be manufactured to various lengths to work with a variety of inserters and their hoppers.

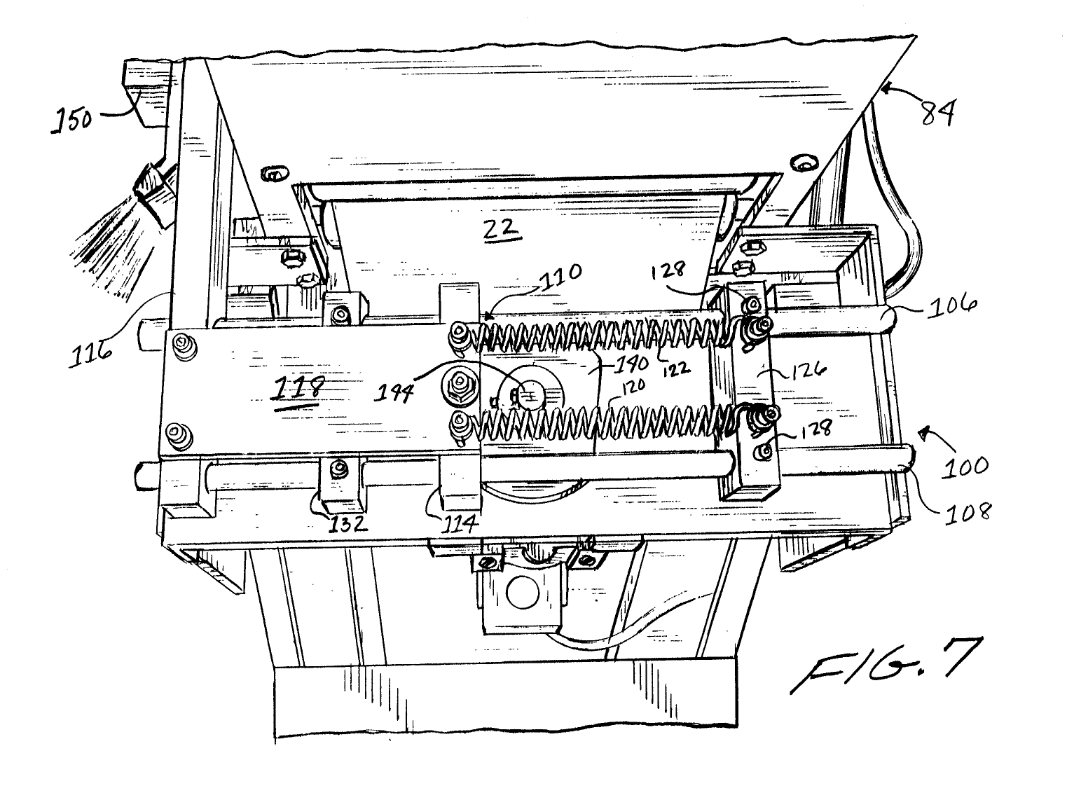

The nose portion 84 mounts jogger assembly 26 that extends along a portion of the incline conveyor assembly 18. More specifically, as shown in FIGS. 2 and 7, the jogger assembly 26 includes a fixed fence or guide rail 92 and a reciprocally mounted fence 94. Fence 94 is mounted to move reciprocally in a linear direction toward and away from fixed fence 92. This reciprocating action of fence 94 aligns the product stream as it moves along the nose section 84 toward the hopper. The front end 98 of the fence 94 that extends along incline conveyor assembly 18 is pitched outwardly to push back any part of the product stream that may skew as it passes paper guide 64 before reaching nose section 84.

A reciprocating mechanism 100 for moving fence 94 is located below nose section 84 behind a guard stream aligner 102. The reciprocating mechanism 100 comprises a pair of cylindrical or tubular races 106, 108 that define a linear path or track along which a reciprocating assembly 110 slides inwardly and outwardly (right and left directions, respectively, in FIG. 5).

More particularly, the reciprocating assembly 110 includes a first slidably mounted rectangular bracket 114, an elongated arm 116 and a fastening plate 118. Fastening plate 118 connects arm 116 and bracket 114 such that arm 116 and bracket 114 slide in unison along races 106, 108. The reciprocating assembly 110 is inwardly biased by means of a pair of springs 120, 122 connected to a second rectangular bracket 126. The second rectangular bracket 126 is fixed to races 106, 108 by means of set screws 128. A third rectangular bracket 132 is provided between arm 116 and first bracket 114 that is also fixedly mounted to races 106, 108.

The reciprocating assembly 110 may be moved inwardly and outwardly by means of a cam 140 located between the first bracket 114 and second bracket 126. The cam 140 is connected to a pivot shaft 144 that is rotated by an electric motor (not shown). The rotation speed of cam 140 is adjusted through control panel 28. In operation, a rotation speed is selected at panel 28 causing an eccentric edge of rotating cam 140 to drive against the first bracket 114 causing the reciprocating assembly 110 to move outwardly (away from second bracket 126) against the action of springs 120, 122. As cam 140 rotates beyond the eccentric edge, pressure against the first bracket 114 is released allowing the reciprocating assembly 110 to return to its starting position under the return action of the inwardly biasing springs 120, 122. Each time the cam 140 rotates, this action is repeated. Thus, as the speed of rotation of the cam 140 is increased, so is the reciprocating action.

Referring again to FIG. 2, the top end of arm 116 includes a two piece mounting bracket 150 for supporting slidably reciprocating fence 94. A square stock support rod 154 is provided to support the reciprocating fence 94 within bracket 150. A Kipp handle 158 is provide to manually loosen bracket 150 in order to move fence 94 forward and rearward along the axis of rod 154. The fence 94 may be adjusted to correspond to the width of the product stream path and the adjustable guide 64.

In operation, the reciprocating fence 94 aligns the product stream by forcing the stream against fixed guide 92 thereby maintaining the rectilinear motion of the product stream along nose section 84 until the printed products drop into the hopper. Thus, the adjustable paper guide 64 and adjustable, reciprocating fence 94 maintain the rectilinear movement of the uniformly shingled product stream up the incline conveyor assembly 18 and over the horizontal nose section 84 until the products drop into the hopper.

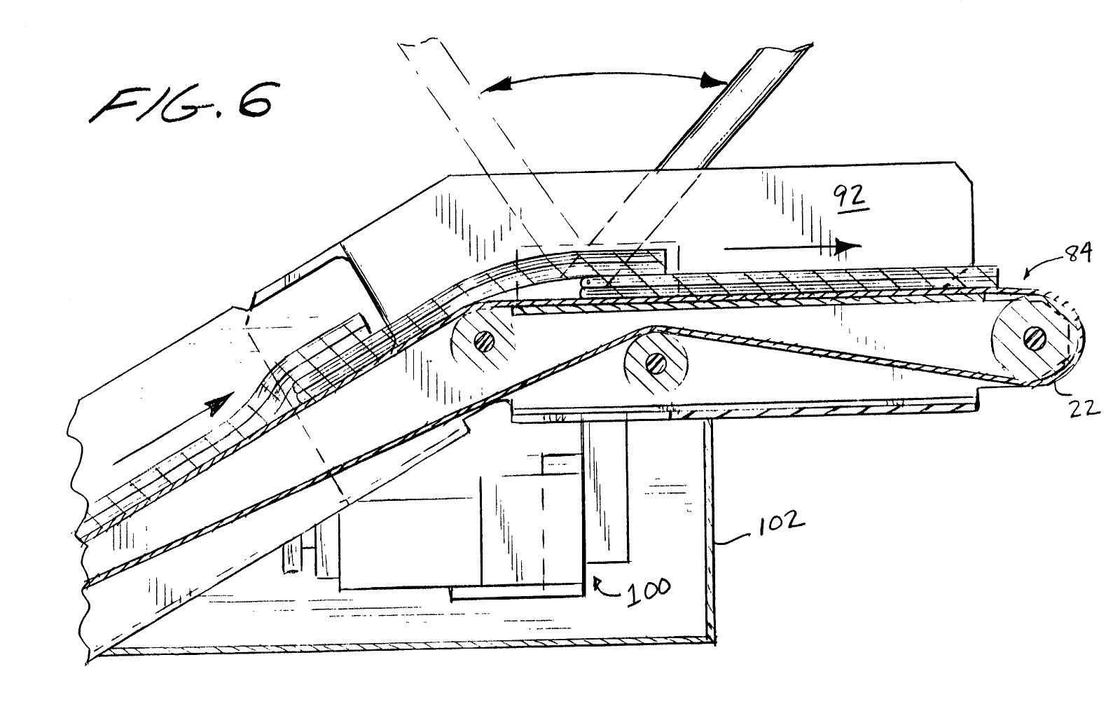

In a preferred embodiment, the conveying device 10 may be configured as either a left-sided, right-sided or dual-sided hopper loader. With respect to the convention that has been adopted herein, the conveying device shown in FIGS. 1-10 may be considered right-sided. That is, the adjustable paper guide 64 and adjustable, reciprocating fence 94 are mounted on the right side of the conveying device 10. However, the device may be changed to a left-sided machine by moving the adjustable paper guide 64 and reciprocating fence 94 to the left side of the conveying device 10, while moving the fixed guide 60 and fence 92 to the right side. Additionally, the reciprocating mechanism 100 must be reversed such that the reciprocating assembly 110 is now on the left side of the conveying device 10.

Alternatively, a second reciprocating fence and assembly can be added to replace fixed fence 92. A second reciprocating assembly and guide may be advantageous for certain types of inserters. Additionally, paper guide 60 may be replaced with an adjustable guide 64. With such a configuration, the conveying device may be used to feed any hopper on any side of the inserter without having to change parts such as would be necessary when changing a right-sided machine to a left-sided machine or vice versa.

The conveying device 10 according to an exemplary embodiment of the present invention is intended to mechanically feed the vast majority of newspaper sections and inserts. Since the conveying device 10, as described, may be adapted or manufactured to feed any hopper, wheels are provided for moving the conveying device 10 into and out of engagement with various hoppers.

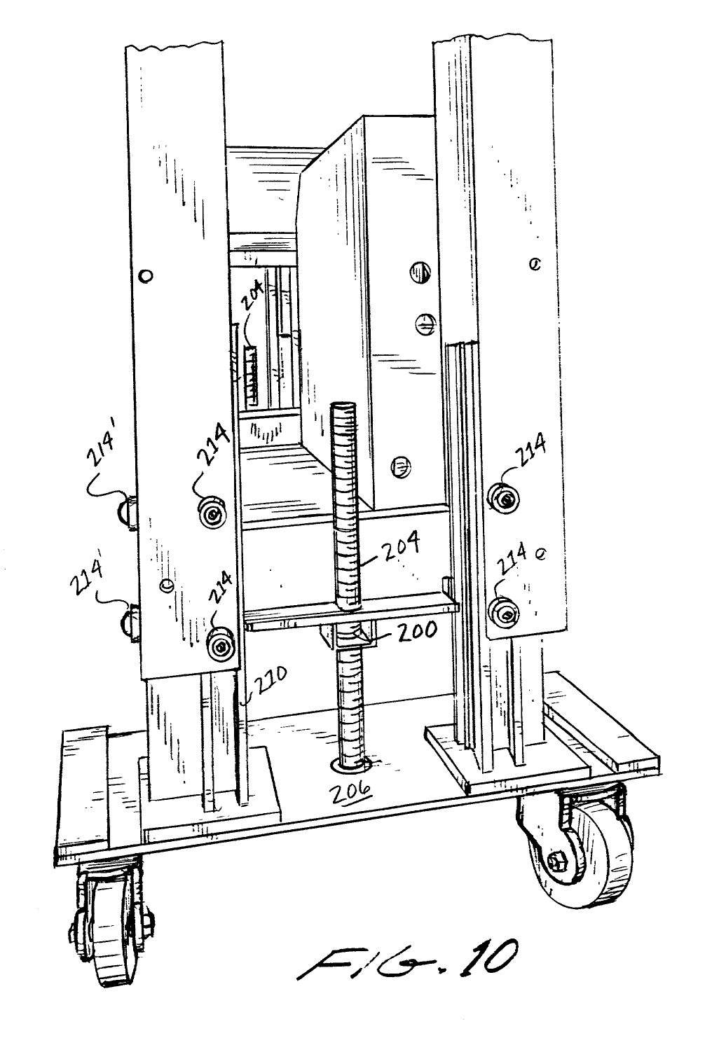

Additionally, since the height of a particular hopper may vary, the vertical height of the conveyor device 10 may be manually adjusted. As shown in FIG. 10, the conveying device 10 includes a height adjustment assembly that comprises a fixed nut 200, a threaded shaft 204 and an adjustment nut (not shown) that is milled or machined to shaft 204. The adjustment nut is located under plate 206 shown in FIG. 10. A height adjustment assembly is disposed on opposite ends of conveying device 10.

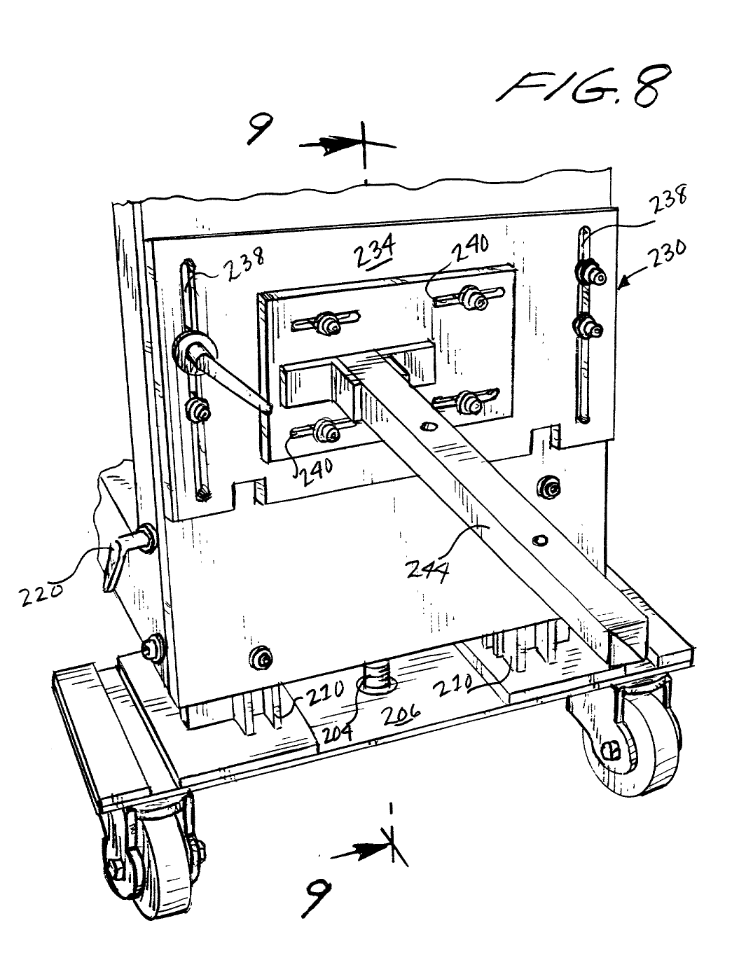

To adjust the height of conveying device 10, the adjustment nut on each side of the conveying device is turned causing treaded shaft 204 to turn. As each threaded shaft 204 is turned, the height of conveying device 10 is raised or lowered along legs 210, depending on whether the adjustment nut is turned clockwise or counter-clockwise. However, it may be necessary to first loosen bolts 214 and 214′ before raising or lowering conveying device 10. Alternatively, to simplify the process, bolts 214 may be replaced with shoulder bolts and bolts 214′ may be replaced by Kipp handles 220, as shown in FIG. 8.

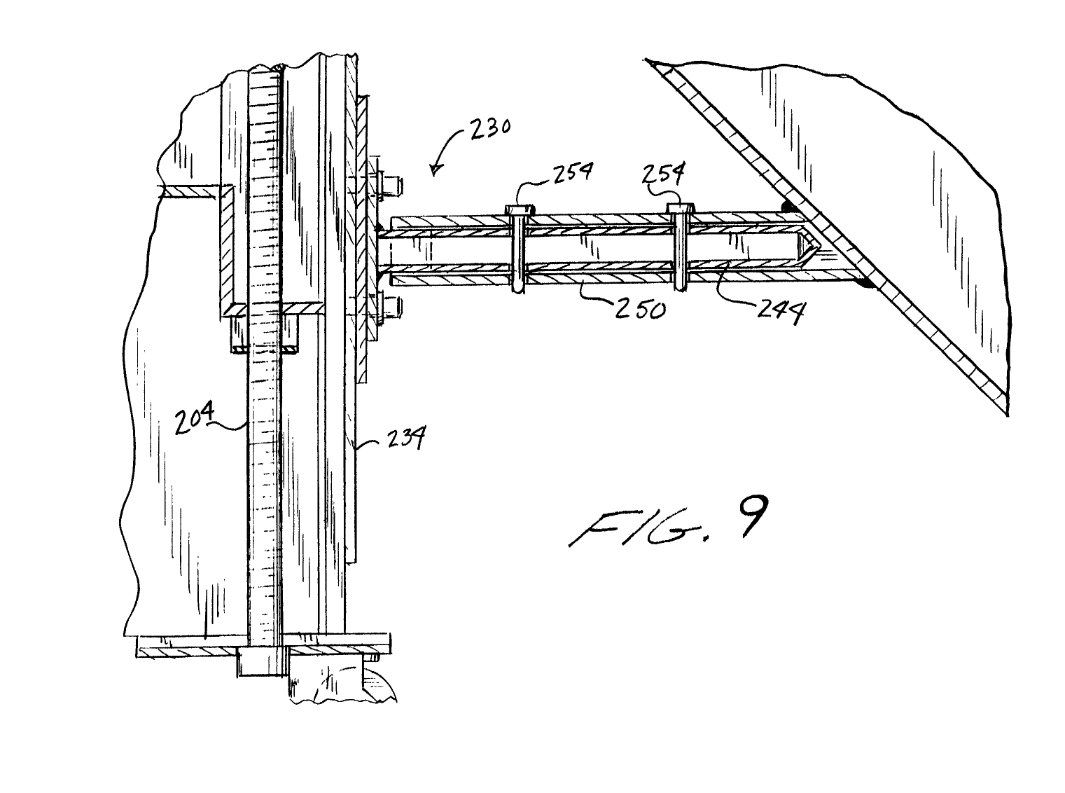

After the conveying device 10 has been moved into position adjacent the inserter and the desired height obtained, the conveying device 10 may be anchored to the inserter using mounting assembly 230, as depicted in FIGS. 8 and 9. Mounting assembly 230 includes a mounting plate 234 that is secured to conveying device 10 and vertically and horizontally adjustable along slots 238 and 240, respectively. The mounting plate 234 includes a shaft 244 that is mated within a coupling 250 (see FIG. 9) mounted to the inserter. Bolts 254 may be used to secure the shaft 244 to the coupling 250.

It will thus be seen that the objects set forth above, among those made apparent from the preceding description, are efficiently attained and, since certain changes or modifications may be made in the above constructions without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed is:

1. A printed product conveyance device comprising a chassis having a first end and a second end, a transport medium extending at an incline between the first end of the chassis and the second end thereof, a support assembly extending at an angle from the chassis adjacent the first end thereof and defining therewith a printed product feed area adapted to receive a stack of printed product, the transport medium transferring printed product from the printed product feed area to a discharge area located adjacent the second end of the chassis, the printed product being moved uniformly from the printed product feed area toward the discharge area under the action of the transport medium.

2. The conveyance device of claim 1 wherein the support assembly further comprises a plurality of rollers for assisting in the feeding of the printed product from the feed area to the discharge area, the plurality of rollers acting to separate the printed product as it moves along the transport medium to the discharge area.

3. The conveyance device of claim 2 wherein the support assembly further comprises a belt extending around the plurality of rollers.

4. The conveyance device of claim 1 wherein the support assembly comprises a second chassis extending at a predetermined angle from the chassis.

5. The conveyance device of claim 4 wherein the predetermined angle is about 90 degrees.

6. The conveyance device of claim 1 wherein the discharge area is defined by a generally horizontal area of the chassis and transport medium.

7. The conveyance device of claim 1 wherein the transport medium transfers printed product from the printed product feed area to the discharge area using a motor.

8. The conveyance device of claim 1 further comprising an alignment gate supported by the chassis adjacent the printed product feed area for maintaining the printed product in alignment as it moves along the transport medium.

9. The conveyance device of claim 8 wherein the alignment gate comprises at least one adjustable fence for accommodating and maintaining the aligned flow of variously sized printed product.

10. The conveyance device of claim 1 further comprising a reciprocating fence mounted to the chassis adjacent the discharge area for aligning the printed product prior to discharge.

11. The conveyance device of claim 1 wherein the transport medium comprises a transfer belt.

12. The conveyance device of claim 1 further comprising means for adjusting the vertical height of the device.

13. The conveyance device of claim 1 further comprising an adjustable locking device for coupling the device to a fixture for receiving the printed product.

14. A conveyance device for feeding newspaper-related product to a newspaper inserter comprising a chassis having a transfer belt extending at an incline between a first end of the chassis and a second end of the chassis, a roller assembly coupled to the chassis adjacent the first end and defining therewith a product feed area for receiving a stack of newspaper-related printed product, a motive device for advancing the transfer belt to move newspaper-related printed product from the product feed area to a discharge area located adjacent the second end of the chassis, a control panel for operating the motive device, and a jogging assembly supported by the chassis adjacent the discharge area to align the newspaper-related product before discharge to the inserter.

15. The conveyance device of claim 14 wherein the chassis and transfer belt extend from the product feed area to the discharge area at a predetermined angle relative to a horizontal axis.

16. The conveyance device of claim 15 wherein the predetermined angle is between approximately 20 degrees and approximately 45 degrees.

17. The newspaper conveyance device of claim 14 wherein the roller assembly comprises a chassis for holding a plurality of cylindrically-shaped rollers for assisting in feeding of newspaper-related product from the product feed area to the discharge area, the rollers acting to separate the newspaper-related product as it is moved along transfer belt toward the discharge area.

18. The newspaper conveyance device of claim 17 wherein the roller assembly further comprises a belt.

19. The conveyance device of claim 14 wherein the roller assembly comprises a second chassis extending at a predetermined angle from the chassis.

20. The conveyance device of claim 19 wherein the predetermined angle is approximately 90 degrees.

21. The conveyance device of claim 14 wherein the discharge area is defined by a generally horizontal extension of the chassis and transfer belt.

22. The conveyance device of claim 14 further comprising an alignment gate supported by the chassis adjacent the product feeding area for maintaining the newspaper-related printed product in alignment as it moves along the transfer belt toward the discharge area.

23. The conveyance device of claim 22 wherein the alignment gate comprises at least one adjustable fence for accommodating and directing the flow of variously sized newspaper-related printed product.

24. The conveyance device of claim 14 wherein the jogging assembly further comprises a reciprocating fence supported by the chassis adjacent the discharge area for aligning the printed product prior to discharge.

25. The conveyance device of claim 13 further comprising means for adjusting the vertical height of the device with respect to the inserter.

26. The conveyance device of claim 13 further comprising an adjustable locking device for coupling the device to the inserter.

27. A newspaper product conveyance device for feeding a newspaper inserter comprising a chassis having a transfer belt extending at an incline between a first end of the chassis and a discharge area located adjacent a second end of the chassis, a roller assembly including a plurality of rollers and a belt advanced under the action of the rollers, the roller assembly extending at an angle from the chassis adjacent the first end and defining with the first end of the chassis a newspaper product feed area for holding a stack of newspaper products, a motor for advancing the transfer belt, a control panel for operating the motor, and a reciprocating fence supported by the chassis proximate the discharge area to align the printed material before discharge to the inserter, whereby the roller assembly and transfer belt cooperate to cause a uniform stream of newspaper product to be transported to the discharge area for discharge to the inserter.
